(19) United States
(12) Patent Application Publication
(10) Pub. No.: US 2007/0179925 A1
(43) Pub. Date: Aug. 2, 2007

(54) Expert system for prescribing and tracking physical activity programs for patients with coronary artery disease and method of creating same

(75) Inventors: Robert Reid, Ottawa (CA); Louise Morrin, Nepean (CA); Sophia Papadakis, Ottawa (CA); Louise Beaton, Ottawa (CA)

Correspondence Address: OGILVY RENAULT LLP, 1981 MCGILL COLLEGE AVENUE, SUITE 1600, MONTREAL, QC, H3A2Y3, CA

(73) Assignee: University of Ottawa Heart Institute, Ottawa (CA)

(21) Appl. No.: 11/342,831

(22) Filed: Jan. 31, 2006

(51) Int. Cl. G06N 5/04

(52) U.S. Cl. 706/60

(57) ABSTRACT

An expert system for assigning and tracking physical activity programs for patients with coronary artery disease provides user interfaces for recruiters who screen and enroll the patients as program participants in the physical activity programs; for coaches who monitor program participants and guide them through the physical activity program; and for program participants who create their own physical activity schedules,and log their physical activities. Expert system algorithms assign predefined physical activity programs to the program participants at predefined program milestones based on predefined criteria.

### CROSS-REFERENCE TO RELATED APPLICATIONS

This is the first application filed for the present invention.

### MICROFICHE APPENDIX

Not Applicable.

### TECHNICAL FIELD

The present invention relates in general to rehabilitation programs for patients with coronary artery disease and, in particular, to an expert system for prescribing and tracking physical activity programs for patients with coronary artery disease and method of creating same.

### BACKGROUND OF THE INVENTION

It is well known that heart disease remains the most common cause of death in North America and the principle form of heart disease is coronary artery disease. It is accepted that physical exercise is an important component in preventing and recovering from coronary artery disease. In particular, it has been demonstrated that people who participate in an appropriate exercise program following myocardial infarction caused by coronary artery disease have a lower incidence of re-infarction and a higher probability of living a longer and more productive life.

There is therefore a recognized need for an efficient mechanism for providing individuals suffering from coronary artery disease with a program that provides a framework and motivation for engaging in regular exercise.

While exercise programs are known, administering and monitoring such programs is costly and time consuming. In addition, traditional hospital-based programs are only accessible to a minority of the eligible population. There therefore exists a need to provide programs that are accessible without geographic and time constraints. Furthermore, tailoring such programs to individual needs requires experience and expertise.

Therefore there exists a need for an expert system for prescribing and tracking physical activity programs for patients with coronary artery disease.

### SUMMARY OF THE INVENTION

It is an object of the invention to provide a method for providing an expert system for prescribing and tracking physical activity programs for patients with coronary artery disease, comprising: defining program participation rules for selecting patients eligible to participate in the program as program participants; defining patient discharge categories for categorizing program participants; defining program participation goals selected by the program participants and used in prescribing the physical activity program for each program participant; designing a plurality of exercise programs for the program participants; and creating an algorithm for assigning an exercise program to each program participant based on the patient discharge category and the program participation goal associated with each program participant.

It is a further object of the invention to provide an expert system for prescribing and tracking physical activity programs for patients with coronary artery disease, comprising: a server for hosting the expert system; a database for storing information required by the expert system; user interfaces for providing access to the expert system by program recruiters, program coaches and program participants; and an algorithm for selecting an exercise program for each program participant at each of a plurality of predetermined time intervals based on predefined selection criteria.

### BRIEF DESCRIPTION OF THE DRAWINGS

Further features and advantages of the present invention will become apparent from the following detailed description, taken in combination with the appended drawings, in which:

FIG. 1 is a schematic view of the deployment of an embodiment of an expert system in accordance with the invention for prescribing and tracking physical activity programs for patients with coronary artery disease;

FIG. 2 is a flowchart illustrating principle steps in designing and creating an expert system in accordance with the invention;

FIG. 3 is a table showing patient discharge categories in accordance with an embodiment of the invention;

FIG. 4 is a flowchart illustrating an overview of the use of the expert system in accordance with the invention;

FIG. 5 is a schematic view of the conceptual behavior of a recruiter and a coach using the expert system in accordance with the invention;

FIG. 6 is a schematic view of the conceptual behavior of a program participant using the expert system in accordance with the invention;

FIG. 7 is a schematic diagram of a conceptual structure of the expert system in accordance with an embodiment of the invention;

FIG. 8 is a schematic diagram of a user interface designed for program participants in accordance with an embodiment of the invention;

FIG. 9 is a schematic diagram of the user interface shown in FIG. 8, illustrating a physical activity planning session referred to as a “tutorial”;

FIG. 10 is a schematic diagram of the user interface showing additional parts of the physical activity planning tutorial;

FIG. 11 is a schematic diagram of the user interface illustrating an embodiment used to input program participant activity log information;

FIG. 12 is a timeline schematically illustrating principle events in a physical activity program structured in accordance with an embodiment of the invention;

FIGS. 13a and 13b are flowcharts illustrating one method of assigning a physical activity program to a program participant in accordance with an embodiment of the invention;

FIGS. 14a to 14d are tables showing physical activity programs in accordance with one embodiment of the invention; and

FIGS. 15a and 15b are a table showing discharge walking programs in accordance with an embodiment of the invention.

It will be noted that throughout the appended drawings, like features are identified by like reference numerals.

### DETAILED DESCRIPTION OF THE PREFERRED EMBODIMENT

The invention provides a method for creating an expert system for prescribing and tracking physical activity programs for patients with coronary artery disease. In accordance with the method, program participation rules are defined for selecting patients eligible to participate in the physical activity program. Patient discharge categories are defined to categorize patients eligible for participation in the program. Program participation goals are also defined, and a participation goal is selected by each program participant. The discharge category is used to select an initial physical activity program for each program participant. Thereafter the physical activity program is modified in accordance with each patient's assessment of their physical activity program, their participation goal, self-recorded activity, the presence of symptoms and/or injuries, and/or an indication that the patient has been scheduled for (or has had) an investigative test. During the program, tailored motivational material is presented to the program participant to inhibit any interruption in the participant's physical activity. The system in accordance with the invention is preferably a web-based application that can be accessed via the internet.

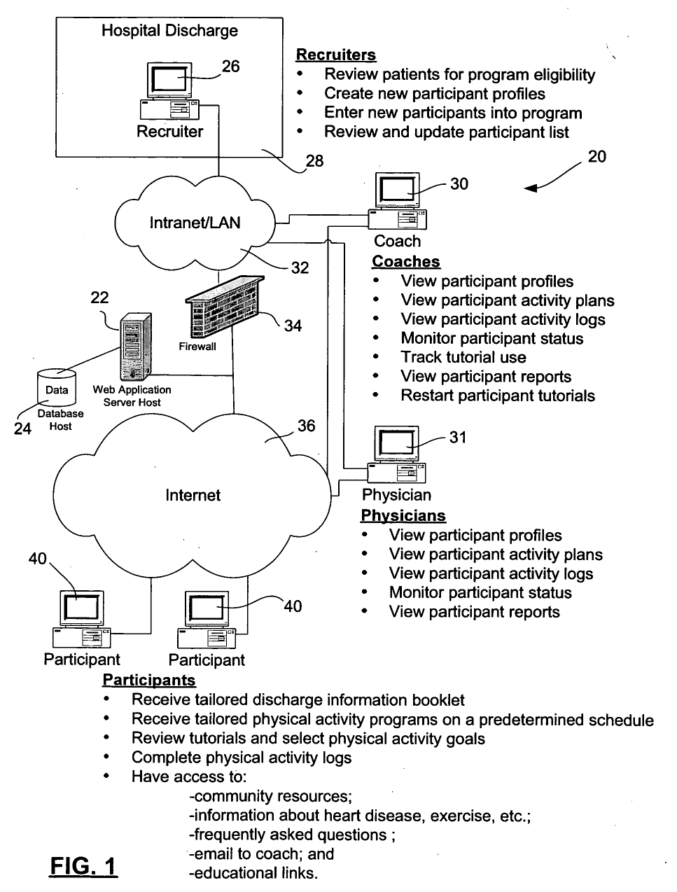

FIG. 1 is a schematic diagram of an exemplary deployment of an expert system 20 in accordance with the invention. In this embodiment, the expert system 20 is hosted by a web application server host 22 that has access to a database host 24 where expert system 20 data is stored, as will be explained below in detail. The web application server host 22 is connected to the public side of an intranet/local area network (LAN) 32 isolated by a firewall 34 from the internet 36.

Recruiters 26 at a hospital discharge unit 28 review coronary artery disease patients to determine whether those patients are eligible to participate in a physical activity program directed by the expert system 20. It should be noted that in this embodiment of the invention, the recruiters 26 are primarily for research purposes and they are not necessarily required by a program modeled in accordance with the invention.

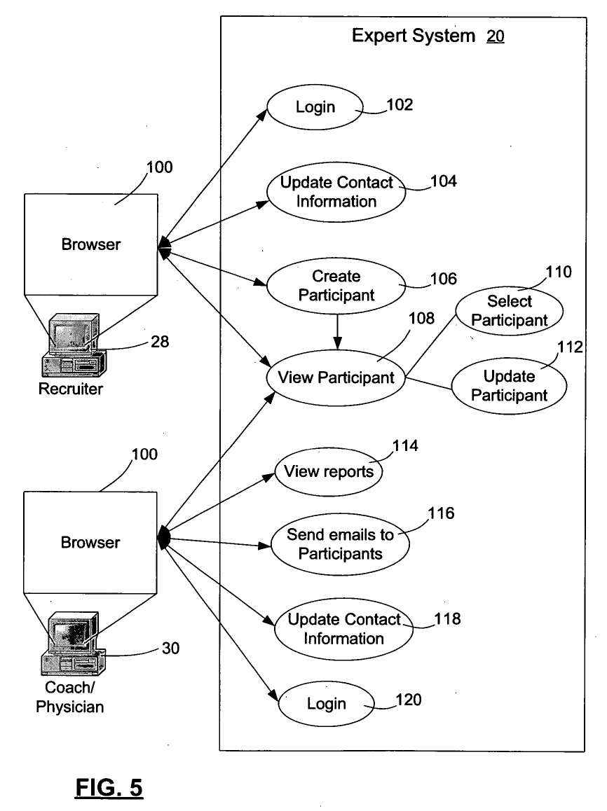

The recruiters 26 create new program participant profiles for those patients who are eligible for participation in the program and enter new program participants 40 into the program. The recruiters 26 may also review and update the program participant list and perform other functions as will be described below in more detail with reference to FIG. 5.

Also connected to either of the intranet/LAN 32 and the internet 36 are coaches 30. Any number of coaches can be connected to the expert system 20. In one embodiment, physicians 31 can also be connected to the expert system 20, and the physicians can perform some of the functions that a coach 30 is able to perform. The coaches 30 and the physicians 31 can view program participant profiles and program participant activity plans. The coaches 30 and the physicians 31 can also view program participant activity logs where program participants record their physical activities, as will be explained below with reference to FIG. 11.

Connected to the internet 36 are the program participants 40 who have internet access using any known access technology. The program participants 40 log on to the web application server host 22 in a manner well known in the art to review instruction sessions called “tutorials”, which are to be completed in a pre-determined series at specific time intervals, and to select a physical activity goal and to receive their revised 6 week physical activity programs. Each tutorial addresses topics essential to developing and maintaining regular physical activity (e.g. goal setting, relapse prevention, etc.). The tutorials are interactive in that the program participant 40 answers questions and receives feedback based on the responses given. Furthermore, in some cases the program participant response will determine subsequent tutorial question(s). Content received during the web tutorial sessions, as well as the physical activity programs and reports are tailored specifically for each program participant 40. The program participants 40, as explained above, also complete physical activity logs and have access to other sources of information, including: local community resources; information about heart disease; information about exercise and best exercise practices, etc.; and answers to frequently answered questions. The program participants 40 may also send e-mails to their coach 30 and use hypertext links to educational sources.

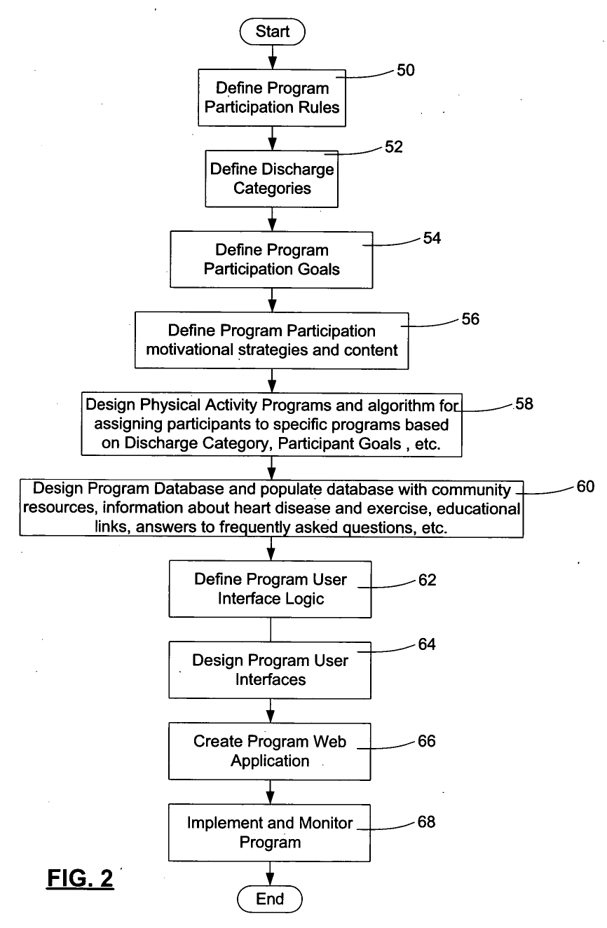

FIG. 2 is a flow diagram illustrating principle steps required to create an implement the expert system 20 in accordance with the invention. In step 50, the program participation rules are defined. A purpose of the expert system 20 is to facilitate rehabilitation of persons with coronary artery disease using a self-monitored exercise program. As will be understood by those skilled in the art, not all post-infarction patients are suitable for a self-monitored exercise program. Consequently, participation rules must be defined in order to select those patients that will benefit from participation in the program.

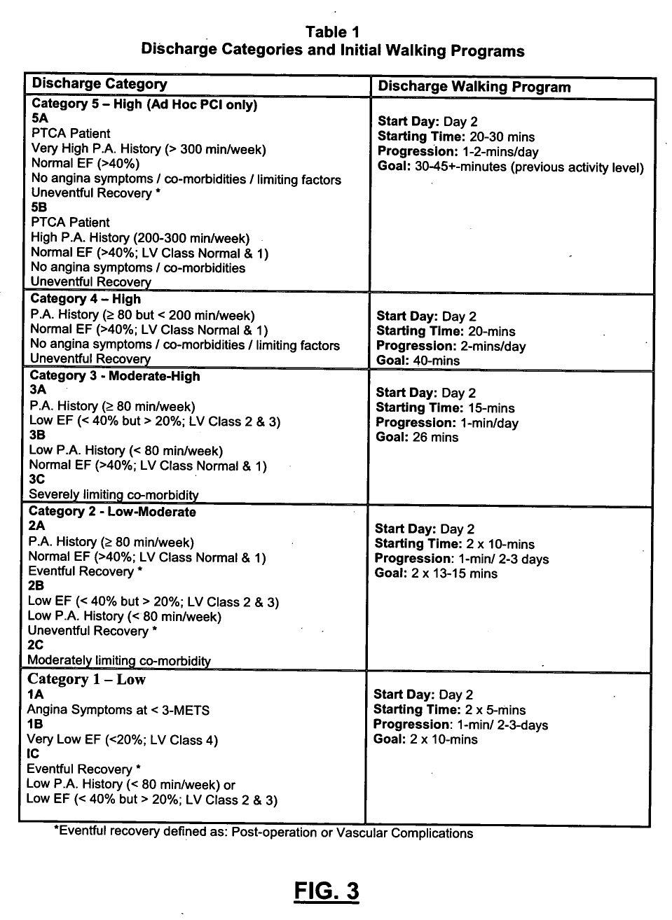

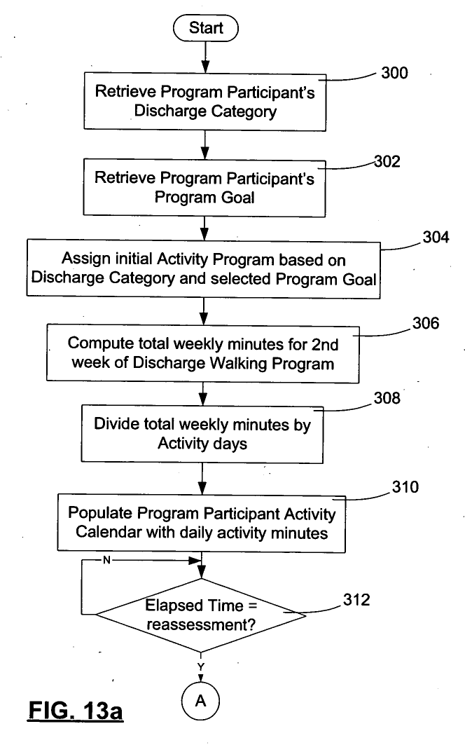

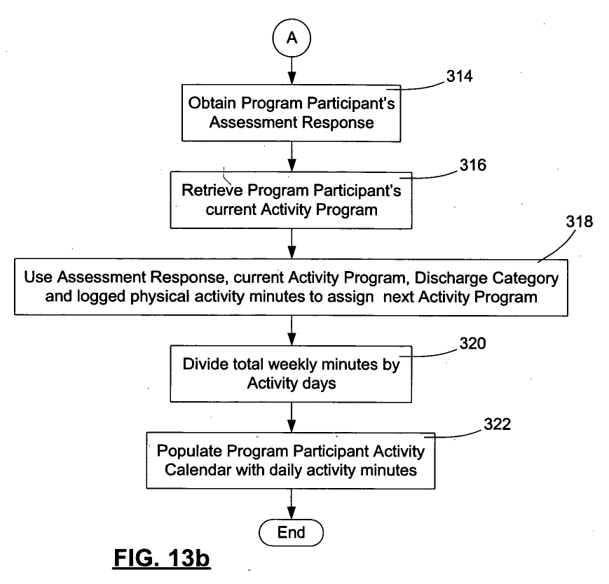

It is also necessary to categorize patients to facilitate physical activity program selection. Consequently, discharge categories (step 52) are likewise defined. Discharge categories in accordance with one embodiment of the invention are shown in Table 1 (see FIG. 3) where each discharge category is described in the left-hand column and a corresponding discharge walking program, which will be explained below in more detail with reference to FIGS. 11 and 13 is shown in the right-hand column. As may be seen, the discharge categories are based on at least: prior physical activity (P.A.) history; infraction recovery history (i.e. eventful or uneventful); and co-morbidity (any other physical ailment or disability). Other criteria may also be considered.

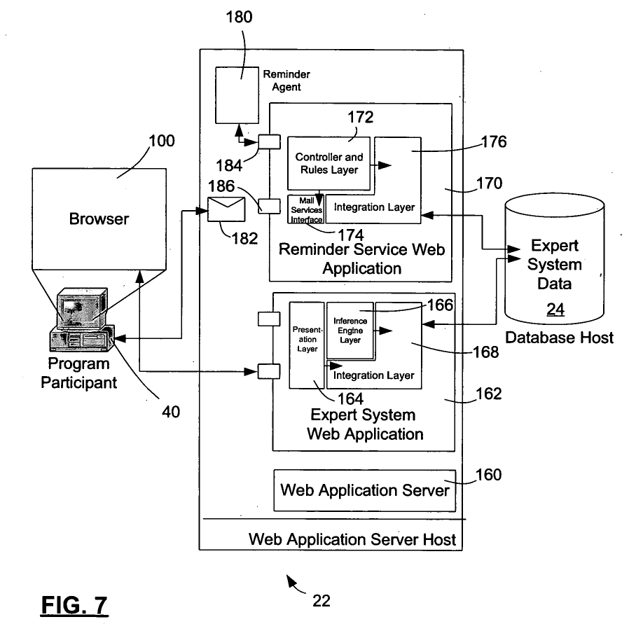

In use of the expert system 20, each program participant must select a participation goal. Those goals are predefined (step 54). The use of program participation goals as a motivational tool will be explained in more detail with reference to FIGS. 7-9.

The expert system 20 is designed on the principle that program participants must be motivated to consistently participate in their planned physical activity. Consequently, motivational strategies and content are developed (step 56). The motivational strategies and content are used to anticipate potential interruptions to a program participant's physical activity and to motivate each program participant 40 to avoid such interruption by guiding them through a motivational planning process, as will likewise be explained below in more detail.

In accordance with the invention, a plurality of physical activity programs are designed (step 58) and an algorithm for assigning program participants to specific programs based on discharge category, program participant goals, etc. as will be explained below in more detail. The expert system 20 requires a program database for storing the information described above with reference to FIG. 1. The database must be populated with community resources, information about heart disease and exercise, education links, answers to frequently answered questions, etc. (step 60). Program user interface logic must also be defined (step 62) and program user interfaces must be designed for the recruiters 26, the coaches 30 and the program participants 40 (step 64). The program web application must then be created in a manner well known in the art (step 66). Thereafter, the expert system 20 is implemented and operated (step 68).

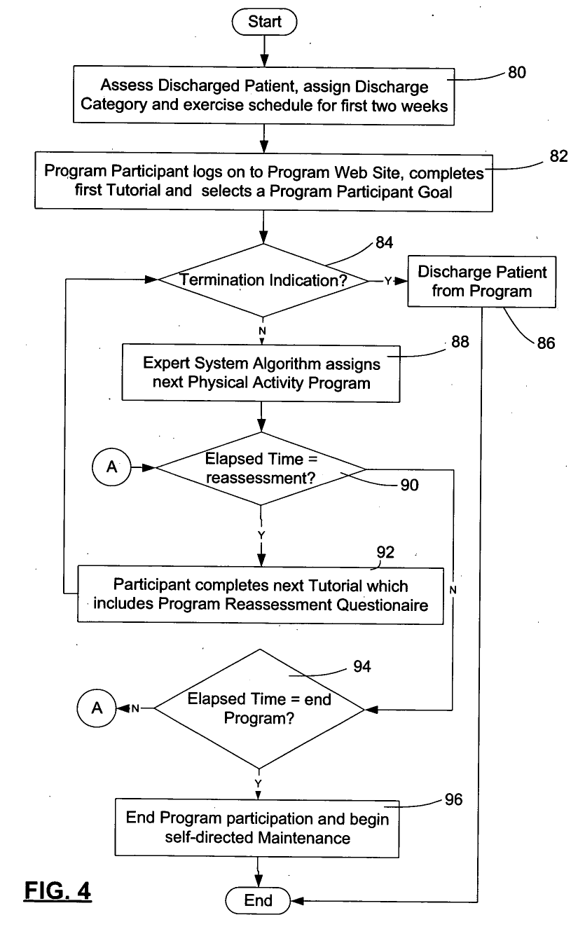

FIG. 4 is a flowchart providing a high level overview of use of the expert system 20 in accordance with the invention. As explained above, discharge patients are assessed for eligibility to participate in the physical activity programs assigned and monitored using the expert system 20. Each discharged patient eligible to be a program participant 40 is assigned a discharge category and a corresponding physical activity schedule for the first two weeks after discharge (step 80). In one embodiment of the invention, the physical activity schedule is provided in a tailored information booklet provided to the discharged patient. The discharge booklet includes information about the program, information about their cardiac event or intervention, guidelines for physical activity, a 2-week physical activity program, as well as detailed instructions about how to access the web application server host 22, how to log on, etc. (step 80).

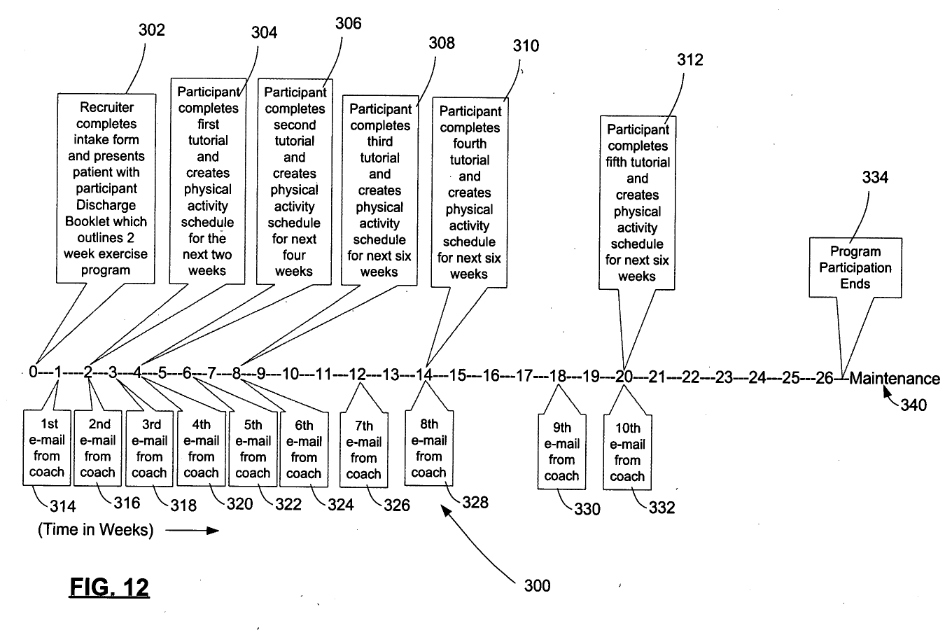

Sometime before the end of the first two weeks, the program participant 40 logs on to the web application server host 22 and completes a first “tutorial” (step 82). During completion of the first tutorial, the program participant 40 selects a program participation goal, the purpose of which will be explained below in more detail. As will be explained below with respect to FIG. 12, the system in accordance with the invention provides five tutorials spaced in time and separated by predetermined time intervals. Each tutorial is an interactive web session that guides the program participant 40 through a program assessment questionnaire and then a physical activity planning process. If the program participant's 40 responses to the reassessment questionnaire indicate that participation in the program should be terminated (step 84) the patient is discharged from the program (step 86) and a program participant's participation in the program ends. Otherwise, the expert system 20 physical activity assignment algorithm assigns a next physical activity program to the program participant (step 88), as will be explained below with reference to FIGS. 13a and 13b.

Thereafter, for each program participant 40, the expert system 20 checks periodically, e.g. daily, to determine whether the elapsed time for reassessment has passed (step 90). If so, the program participant 40 is required to complete a next tutorial, which includes a program reassessment questionnaire. If the program participant 40 answers to the program reassessment questionnaire indicate a termination indication (step 84) the participant is discharged from the program (step 86) as described above. Otherwise, the expert system physical activity algorithm assigns a next physical activity program (step 88) as likewise described above. If it is determined in step 90 it is not time for a reassessment, it is determined in step 94 whether the elapsed time indicates that the program has come to an end. If so, the expert system 20 terminates involvement with the program participant 40 and the program participant 40 begins self-directed physical activity maintenance. Experience has shown, as will be explained below with reference to FIG. 12, that after 26 weeks of involvement with the expert system 20, most program participants continue their physical activity as a self-directed program.

FIG. 5 is a schematic view of conceptual behavior of the recruiters 28 and coaches/physicians 30 interacting with an embodiment of the expert system 20. The recruiters 28 and the coaches/physicians 30 access the expert system 20 through their own world wide web browsers 100.

The recruiters 28 can log into the system using a logon interface 102. Once logged in, a recruiter 28 can update their contact information using a suitable interface 104. Recruiters can also create program participants 106, view the program participants 108 by selecting a program participant 110. A recruiter 28 can also update a program participant 112.

The coach 30 can likewise view a program participant 108 by selecting the program participant 110. Coaches can also update program participant records 112 and may be permitted to use the create program participant facility 106, depending on system administrative constraints. As will be understood by those skilled in the art, these facilities are available to the coach only after they log in using a logon interface 120. Once logged in, the coach 30 can also update their contact information 118. The coach 30 can likewise view reports 114, which include physical activity reports of the respective participants assigned to the coach 30. If those reports indicate that a program participant 40 is not meeting their assigned program objectives, or indicate any other anomaly, the coach 30 can send an e-mail to participant 116 to encourage the participant or address the problem.

In one embodiment of the invention, the coach 30 is granted security access to permit them to re-set or modify a participant's physical activity program. For example, if a participant 40 indicates in an assessment at the beginning of a tutorial that they are experiencing a change in their symptoms, or they are experiencing new symptoms, the participant 40 will receive a physical activity program that is less stringent. This functionality is built into algorithm. The same result is true if they indicate that they are scheduled for or have undergone an investigative test. In order for their program to be returned to normal, the coach will have to consult with the participant 40, the participant's physician, and test results and, if appropriate, re-set the program using the coach's view. As well, in accordance with an embodiment of the invention only a coach 30 is granted security clearance to reset a tutorial. Should a program participant 40 get part-way through a tutorial and answer a question incorrectly, or wish to make a change after they have moved to a new page, they may not have the ability to go back and correct it. The coach 30 has the ability to reset their tutorial to the beginning so that the program participant 40 can start the tutorial over again).

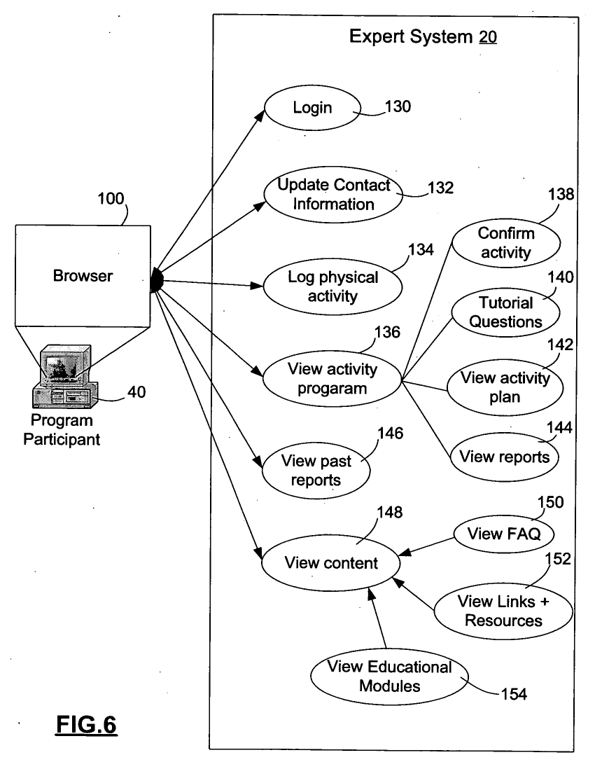

FIG. 6 is a schematic diagram illustrating conceptual behavior of program participants 40 interacting with the expert system 20. The program participants 40 interact with the expert system 20 using a worldwide web browser 100, as explained above. The program participant 40 accesses the expert system 20 through a logon interface 130. The program participant 40, once logged on, can update their contact information 132. After the program participant 40 is assigned a physical activity program 136, the program participant 40 can confirm the activity plan 138, as will be explained below in more detail. The program participant 40 can also answer tutorial questions 140 as explained above, view the physical activity plan 142 and view reports respecting the physical activity that they have logged using a physical activity log interface 134 as will be explained below with reference to FIG. 11.

The Program participant 40 can also view past reports 146 of their physical activity. The program participant 40 can likewise view expert system 20 content which, as explained above with reference to FIG. 1, includes answers to frequently asked questions 150, links 152 to educational information and local resource information; and educational modules respecting information related to heart disease, exercise, etc.

FIG. 7 is an overview of the conceptual structure of web application server host 22 and its interaction with the program participant 40 through worldwide web browser 100 and electronic mail 182. As shown in FIG. 7, the program participant 40 interacts through the worldwide web browser 100 with the expert system web application 162, which runs over a web application server 160. Expert system web application 162 includes a presentation layer 164 that provides the program participant interface. An inference engine layer 166 provides inference logic that moves information between the presentation layer 164 and an integration layer 168 and performs logic functions. The integration layer provides an interface to the expert system data stored on the database host 24.

In accordance with an embodiment of the invention, the web application server 160 also supports a reminder service web application 170. The reminder service web application 170 includes a controller and rules layer 172 that determines when reminders are to be sent to program participants 40. The controller and rules layer 172 controls a mail services interface 174 which is responsible for generating e-mail messages 182 that are sent to program participants 40 when reminders are required. The controller and rules layer 172 interacts with an integration layer 176 to retrieve data from the expert system data stored on database host 24. A reminder agent 180 is a runtime instance that is executed as a scheduled daily task. A reminder agent starts the reminder service web application, which searches the expert system data for reminders that should be sent for the day. The reminders occur at predetermined intervals as will be explained below with reference to FIG. 12. Each predetermined interval is associated with a predefined e-mail message that is sent to an e-mail address of the program participant 40 stored in the expert system data. The mail services interface 186 is used to generate the e-mail messages 182. A reminder agent interface 184 is used to start the reminder service web application 170.

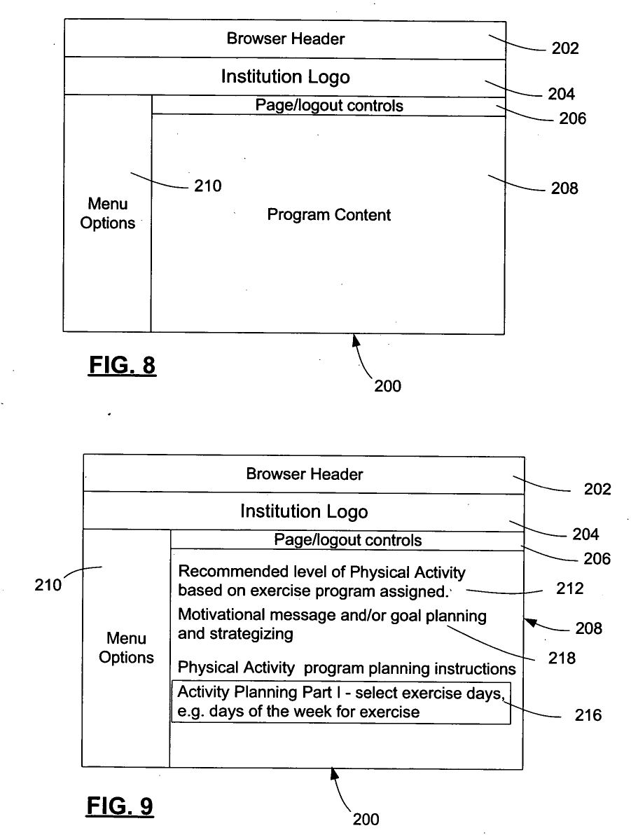

FIG. 8 is a schematic diagram of a user interface presented to the program participants 40. The user interface 200 includes a standard browser header 202, an institution logo bar 204 and page/log out control bar 206. A left sidebar 210 provides menu options. As shown in FIG. 11, in one embodiment the menu options permit a program participant 40 to: view their activity program; view their activity log and input physical activity log records; view their tutorial schedule; view information about heart disease; view information about exercise and exercise essentials; access educational links; e-mail their coach; and, access forms provided for various purposes associated with the expert system 20. The menu sidebar always displays a welcome message with first name and last name of the program participant 40. A program content pane 208 displays relevant content depending on a selection made from the menu sidebar and data retrieved from the expert system 20.

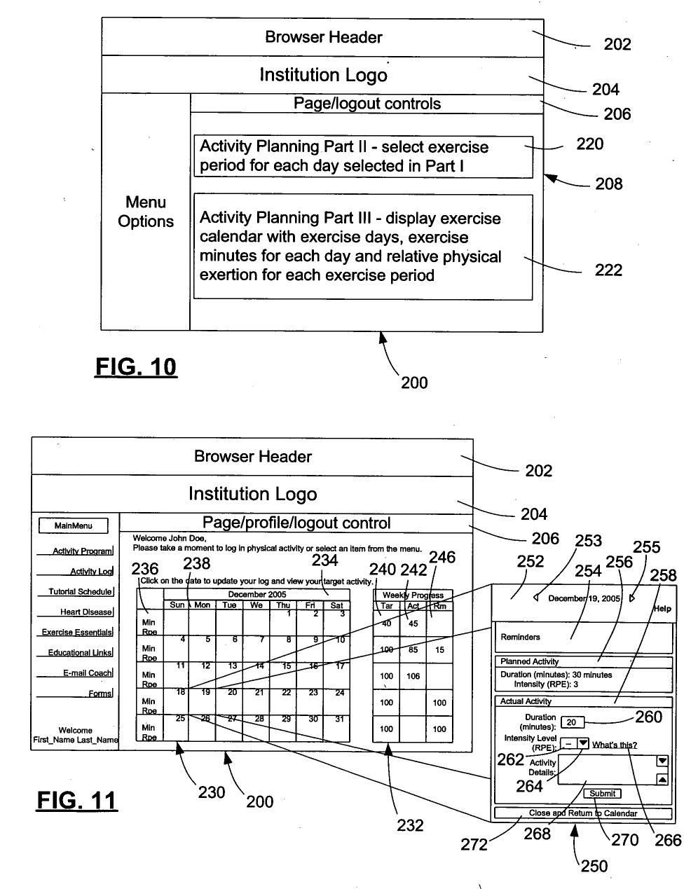

FIG. 9 shows the program participant interface 200 shown in FIG. 8 schematically displaying program content associated with a tutorial presented to the program participant 40. At the top of the program content pane 208 is a recommended level of physical activity based on the exercise program assigned to the program participant 40, as explained above with reference to FIG. 4. An area 218 displays motivational messages and/or goal planning and strategizing. An area 216 has the physical activity program planning instructions and physical activity planning part 1, in which the program participant 40 selects the days of the week on which they intend to exercise for the time intervals specified in the tutorial. As will be understood by those skilled in the art, goal planning and strategizing may require several display panes 208 and the example shown in FIG. 9 is not intended to realistically characterize the amount of space required for that activity.

FIG. 10 shows the program participant user interface 200 used for activity planning parts 2 and 3. In area 220, activity planning part 2 permits a program participant 40 to select a period of each day when they intend to exercise. In one embodiment, the day is divided into morning, afternoon and evening and the program participant 40 must select one of those options for each day on which physical activity is planned. After the selections in area 220 are completed, the expert system 20 divides the recommended activity minutes per week by the number of days, assigns a computed number of minutes to the designated activity days, and displays an exercise calendar with exercise days, exercise minutes for each day and a relative perceived exertion (RPE) for each exercise period.

FIG. 11 shows the program participant interface 200 displaying an activity calendar in accordance with one embodiment of the invention. The activity calendar 230 permits a program participant 40 to log their physical activity. The activity calendar 230 includes a left hand column 236 which provides headings for the minutes and intensity, e.g. relative perceived exertion (RPE) for each day's activity. The activity calendar may display in a calendar area 238 the minutes and RPE for each day selected for exercise. Alternatively, the calendar may be constructed as shown where clicking on a particular day displays an overlaid window 250 that includes that information, as will be explained below. A header 234 for the activity calendar 230 informs the program participant 40 of the month and the year. A summary window 232 includes three columns. A first column 240 provides a target in minutes for the activity program assigned to the program participant 40 by the expert system 20. A column 242 provides a running total of the actual activity minutes logged. A column 246 displays the minutes remaining to be logged, i.e. column 240 minus column 242. Column 246 may display a blank if the amount in column 242 is greater than the amount in column 240.

As shown to the right of FIG. 11, clicking on one of the days of the activity calendar 230 displays an overlaid window 250 containing a header 252 that displays the date, in this example Dec. 19, 2005. Navigation arrows 253,255 permit the program participant 40 to move to a previous day (navigation arrow 253) or a next day (navigation arrow 255), in a manner known in the art. The header also displays a help button. When the help button is selected, help text is presented explaining information displayed and what information the program participant 40 is expected to input. Below the header 252 is a reminder window 254 which includes a reminder text. The reminder text is inserted by the reminder service web application 170, which may be any pre-selected reminder message. A planned activity section 256 sets out an assigned duration of exercise in minutes and a suggested intensity (RPE) of the exercise. In this example, the assigned duration is 30 minutes and the RPE is 3. An actual activity section 258 permits the program participant 40 to enter the actual duration, intensity level and details of the physical activity actually performed on the selected day. In this example the actual activity section is partially completed. A duration 260 of twenty minutes has been entered. The intensity value has not yet been entered in the intensity level input window 262. An intensity (RPE) value can be selected by clicking on a pull-down menu 264. Help information is available at 266 to explain what the relative perceived exertion (RPE) is and how it should be represented. In the activity details area 268, the applicant types a brief description of the activity, i.e. “bike riding”, “walking briskly” or “swimming”, etc. The applicant then selects the submit button 270 to save the information and selects the “close and return to calendar” button 272 to close the overlaid window 250.

FIG. 12 sets out a timeline showing events in the physical activity program in accordance with an embodiment of the invention. As can be seen at 302, at week zero the recruiter 26 completes an intake form and presents an eligible patient with a participant discharge booklet that outlines a two week exercise program to be started on Day 2 after discharge (see Table 1). The discharge booklet explains the physical activity program and provides the program participant 40 with instructions for logging on to the web application server host 22 to complete a first, tutorial at the end of the second week. At 304 the program participant 40 completes the first tutorial and creates a physical activity schedule for the next six weeks based on a physical activity program assigned by the expert system 20.

At weeks one and two, the program participant 40 receives first and second e-mails 314, 316 sent by the mail services interface 174 of the reminder service web application 170 shown in FIG. 7. After completing the two weeks of the six-week program, at 306 the participant completes a second tutorial and receives a revised physical activity program based on their progress over the first couple of weeks. This revised program will carry them through to the beginning of week eight. A third e-mail 318 and fourth e-mail 320 are sent to remind the program participant 40 of the necessity to complete the second tutorial. A fifth e-mail 322 and sixth e-mail 324 are sent at weeks six and eight to remind the program participant 40 that a third tutorial must be completed at the end of week eight.

As shown at 308, the program participant 40 completes the third tutorial and creates a physical activity schedule for the next six weeks, which carries the program participant 40 through to week fourteen. At week twelve an e-mail 326 and at week fourteen an e-mail 328 are sent to remind program participant 40 of the requirement to complete the fourth tutorial at the beginning of the fourteenth week. As seen at 310, the program participant 40 completes the fourth tutorial and creates a physical activity schedule for the next six weeks which carries the program participant 40 through to the end of the nineteenth week. At week eighteen a ninth e-mail 330 is sent, and a tenth e-mail is sent at week twenty to remind the participant that the fifth tutorial must be completed at the end of the nineteenth week. It should be noted that although e-mails 314-332 are automatically generated by the reminder service web application 170 each appears to originate from the program participant's coach 30. As shown at 312, at the beginning of week 20 the program participant 40 completes the fifth tutorial and creates a physical activity schedule for the next six weeks. At the end of week twenty-six, participation in the program ends as shown at 334 and a 26 week self-administered physical activity maintenance period begins in the Cardio-Fit application. During maintenance a participant 40 still has access to the website, and is able to log their physical activity. They also receive an updated physical activity program based on their logged activity every 6 weeks. They do not have access to the personal coach during this time. In addition, during the maintenance period, should they indicate that they are experiencing symptoms, or are scheduled to have an investigative test, they will be discharged from the program. Discharged participants have to be re-referred back into the program to continue.

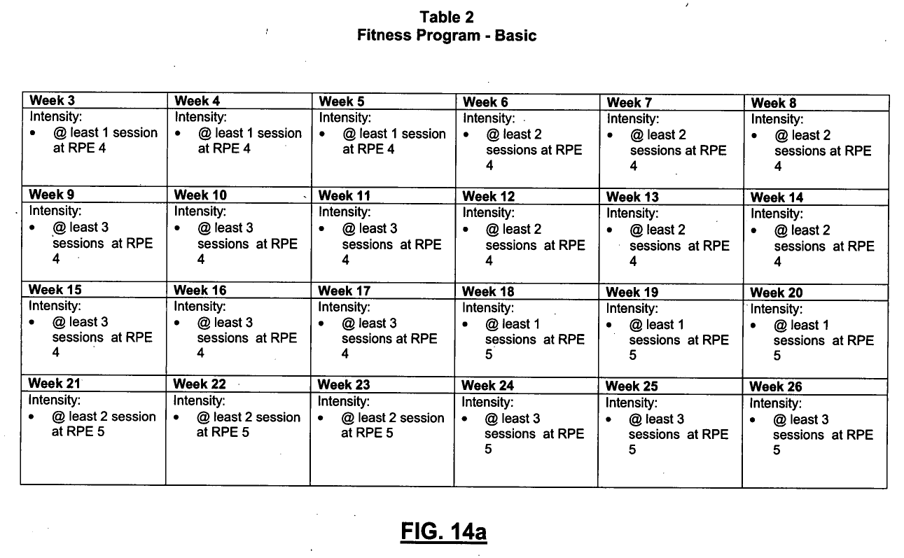

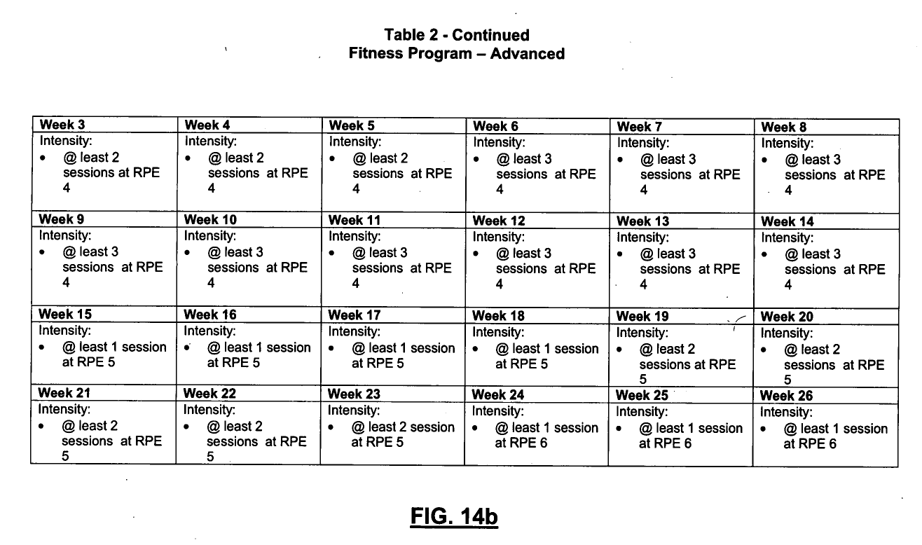

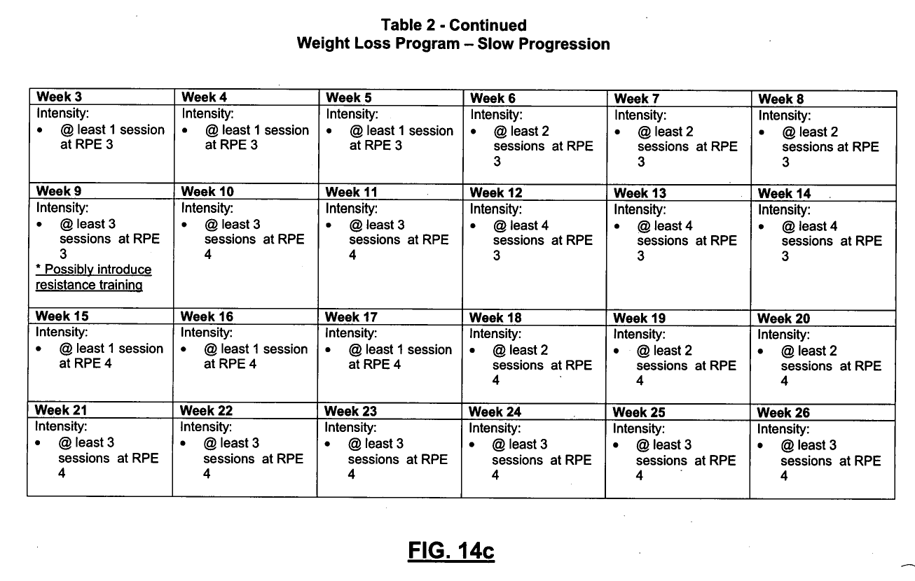

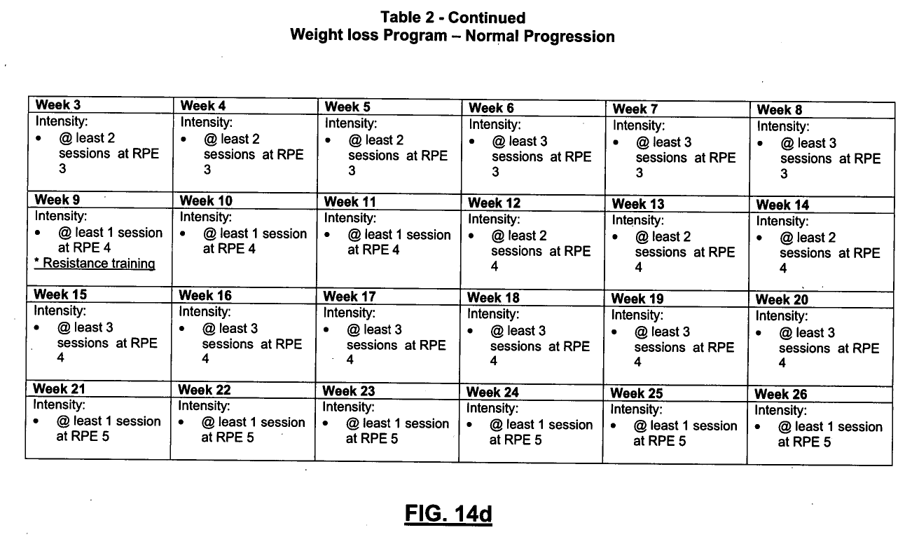

FIGS. 13a and 13b are a flowchart illustrating one method of assigning activity programs to a program participant 40 after the program participant completed their discharge activity program and their first tutorial, as explained above. In step 300, the expert system 20 retrieves the program's participant's discharge category assigned by the recruiter 26 (step 300). The expert system 20 then retrieves the participant's program goal selected when the program participant performed the first tutorial (step 302). The expert system 20 then assigns an initial activity program based on the discharge category and the selected program goal. In accordance with one embodiment of the invention, the program goals are: 1) to lose weight; 2) to improve cardiac risk factors; 3) to improve fitness; 4) to better manage stress; 5) to reduce cardiac symptoms; 6) to prepare for a return to work; 7) to resume leisure or recreational activities; and 8) to improve muscle strength. In accordance with that embodiment of the invention, four activity programs are used. Those four activity programs are set out in Table 2, shown in FIGS. 14a-14d.

In accordance with one embodiment of the invention in step 304 an initial activity program is assigned as follows: 1) goal 1 plus discharge category 2B, 2C (see Table 1) is assigned Weight-Loss Slow Progression (P1) (see Table 2); goal 1 plus discharge category 2A, 3, 4 or 5 is assigned Weight-Loss Normal Progression (P2); goal 1 plus discharge category 1 is assigned Weight-Loss Slow Progression (P1); goals 2-8 plus discharge category 2B or 2C is assigned Weight-Loss Normal Progression (P2); goals 2-8 plus discharge category 2A, 3 or 4 is assigned Fitness Basic (P3); goals 2-8 plus discharge category 5 is assigned Fitness Advanced (P4); and goals 2-8 plus discharge category 1 is assigned Weight-Loss Slow Progression (P1).

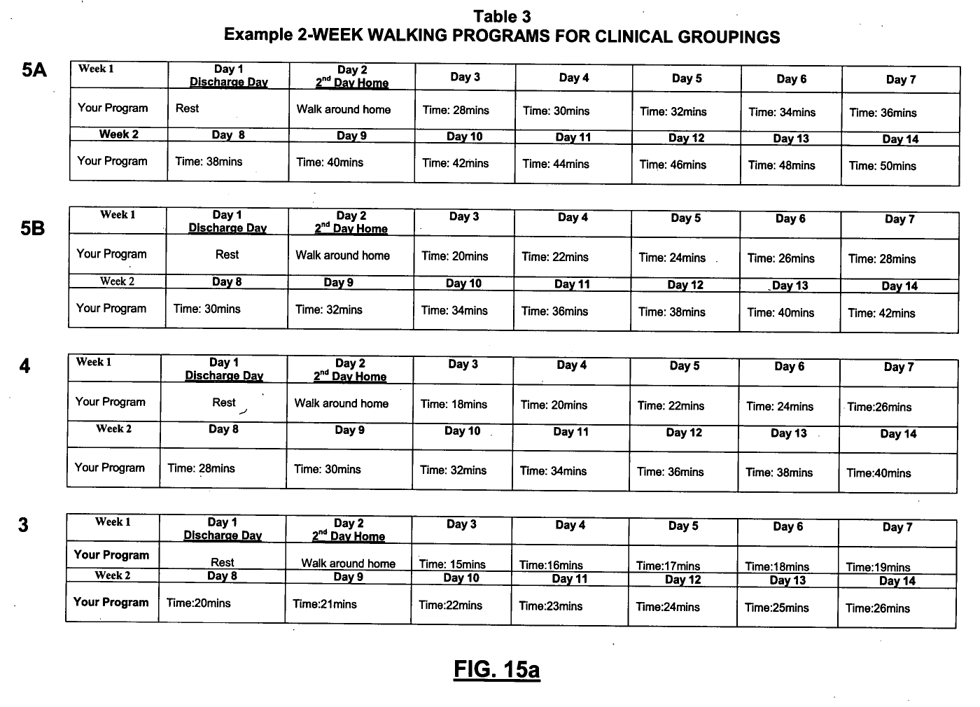

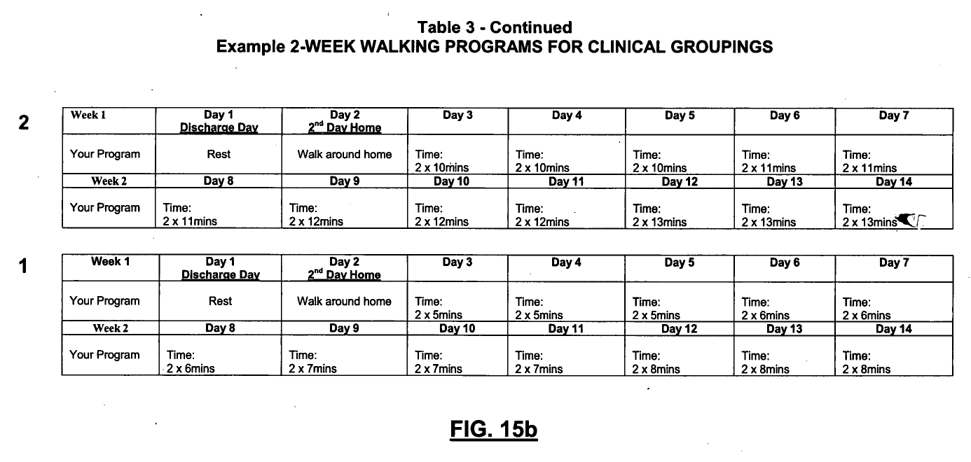

After selecting an initial activity program based on discharge category and selected program goal as described above (step 304), the expert system 20 computes a total weekly minutes for the second week of the discharge walking program (step 306) set out in Table 3, shown in FIGS. 15a and 15b.

The expert system 20 then divides the computed total weekly minutes by the activity days chosen by the program participant 40 (step 308), as described above with reference to FIG. 11. The expert system 20 then populates the selected days of the program participant's activity calendar with daily activity minutes (step 310). The expert system 20 periodically checks whether elapsed time equals a reassessment event, (step 312) as described above with reference to FIG. 4. After the program participant 40 completes a reassessment questionnaire, the expert system 20 obtains the program participant's reassessment responses (step 314).

In accordance with an embodiment of the invention, the program participant 40 is asked the reassessment question, “How have you been finding the exercise program so far?”. In response, the participant can choose one of three answers. Those answers are: Answer 1: “Just Right (I am having no problem maintaining the prescribed intensity or duration)”; Answer 2: “Too easy (I am finding the prescribed intensity or duration too easy, I would like something more challenging)”; Answer 3: “Too Hard (I am having trouble maintaining the prescribed intensity or duration)”. The expert system 20 uses the reassessment response, current activity program, discharge category, and logged physical activity to assign a next activity program (step 318).

In accordance with one embodiment of the invention, that assignment of the next activity program is accomplished as follows: any of the activity programs with any one of the discharge categories, plus Answer 1 equals remain in the same program; P3 plus discharge categories 2A, 3 or 4 plus Answer 2 equals move up to Fitness Advanced (P4); P2 plus discharge categories 2A, 3 or 4 plus Answer 2 equals move up to Fitness Basic P3; P1 plus discharge categories 1A, 1B, 1C, 2B or 2C plus Answer 2 equals move up to Weight-loss Normal Progression (P2); P4 plus discharge category 5 plus Answer 3 equals move down to Fitness Basic (P3); P3 plus discharge categories 2A, 3, or 4 plus Answer 3 equals move down to Weight-lose Normal Progression (P1).

The expert system adjusts the total weekly minutes through a series of steps. (1) Pre-defined new targets for the total minutes to be achieved within the last week (i.e. week 6) of a new six-week physical activity program are determined based on the average weekly total of minutes logged over the last two weeks of the previous physical activity period. The size of the increase in total weekly minutes (5 minutes to 10 minute increments) over the course of the new 6 week physical activity program is then calculated by subtracting the average weekly total (from previous period) from the new 6 week target. The size of the increment then determines the total weekly minutes for each week of the new six week physical activity program. The Weekly total is then divided by the number of days (minimum of 3)chosen by the patient to exercise throughout the week (step 320) to obtain daily activity minutes, and populates the program participant activity calendar with daily activity minutes (step 322).

For example, a program participant 40 who averaged 120 minutes/week over the last 2 weeks of their previous physical activity program, would be assigned 150 minutes as a target for week 6 of their new physical activity program. The new target less the average of the last 2 weeks, i.e. 150−120=30 minutes, so the weekly total over the next 6 weeks is increased by 5 minutes/week (i.e week 1=125 minutes; week 2=130 minutes; week 3=135 minutes; week 4=140 minutes; week 5=145 minutes; and, week 6=150 minutes). The total weekly minutes is then divided by the number of days the program participant 40 selected to be active when they planned their schedule in the course of their last tutorial.

The expert system 20 therefore provides a comprehensive, self-governing process that successfully facilitates the rehabilitation of coronary heart disease patients in a very safe, economical and efficient way.

Although specific embodiments of the invention have been described above, it will be understood that the algorithms described can be modified, as can the architecture of the expert system 20. The scope of the invention is therefore intended to be limited solely by the scope of the appended claims.

1. A method of providing an expert system for prescribing and tracking physical activity programs for patients with coronary artery disease, comprising:
defining program participation rules for selecting patients eligible to participate in the program as program participants;
defining patient discharge categories for categorizing patients eligible for participating in the program as the program participants;
defining program participation goals selected by the program participants and used in prescribing the physical activity program for each program participant;
designing a plurality of exercise programs for the program participants; and
creating an algorithm for assigning an exercise program to each program participant based on the patient discharge category and the program participation goal associated with each program participant.

2. The method as claimed in claim 1 further comprising defining program participation motivational logic for encouraging the program participants to follow their exercise programs to recover form coronary artery disease.

3. The method as claimed in claim 1 further comprising designing a program database and populating the database with at least one of:
community resource information about where the program participants can exercise in their respective local areas, receive advice or assistance;
information about heart disease;
information about exercise and best practices for exercising;
educational links to web sources of relevant information; and
answers to questions frequently asked by program participants.

4. The method as claimed in claim 1 further comprising defining user interface logic for program recruiters, program coaches and program participants.

5. The method as claimed in claim 4 further comprising designing user interfaces for program recruiters, program coaches and program participants.

6. The method as claimed in claim 5 wherein designing a user interface for the program recruiter comprises creating a user interface that permits the program recruiter to:
login to the expert system;
update contact information;
create program participant records;
select a program participant record;
view a program participant record; and
update a program participant record.

7. The method as claimed in claim 5 wherein designing a user interface for the program coach comprises creating a user interface that permits the program coach to:
login to the expert system;
update contact information;
select a program participant record;
view a program participant record;
update a program participant record;
view reports respecting participation in the program by the program participants, and their physical activity; and
send e-mails to the program participants to remind the program participants of upcoming program events, answer program participant questions, and motivate participation in the program.

8. The method as claimed in claim 5 wherein designing a user interface for the program participant comprises creating a user interface that permits the participant to:
login to the expert system;
view their physical activity calendar; and
log their physical activity.

9. The method as claimed in claim 8 wherein creating the user interface for the participant further comprises creating a user interface that permits the program participant to:
access information about heart disease, exercise, and community resources; and
access educational links.

10. The method as claimed in claim 8 wherein creating the user interface for the participant further comprises creating a user interface that permits the program participant to e-mail a coach assigned to them by one of a recruiter and the expert system.

11. An expert system for prescribing and tracking physical activity programs for patients with coronary artery disease, comprising:
a server for hosting the expert system;
a database for storing information required by the expert system;
user interfaces for providing access to the expert system by program recruiters, program coaches and program participants; and
an algorithm for selecting an exercise program for each program participant at each of a plurality of predetermined time intervals based on a respective patient discharge category and a program participation goal associated with each program participant;
wherein each program participant is selected, in accordance with predefined program participation rules, from among patients suffering from coronary artery disease; and wherein the respective patient discharge category is selected from among a set of predefined patient discharge categories.

12. The expert system as claimed in claim 11 wherein the server comprises a web application server host.

13. The expert system as claimed in claim 12 further comprising a reminder service web application for sending reminders to program participants.

14. The expert system as claimed in claim 13 wherein the reminder service web application further comprises a mail services interface for generating e-mail reminders and sending the generated e-mail reminders to the program participants.

15. The expert system as claimed in claim 11 wherein the algorithm is hosted by an expert system web application.

16. The expert system as claimed in claim 15 wherein the expert system web application comprises;
a presentation layer that supports the user interfaces;
an inference engine layer inference engine layer that provides inference logic that moves information between the presentation layer and an integration layer; and
the integration layer that performs logic functions.

17. A method of promoting recovery of patients suffering from coronary artery disease, comprising:
screening the patients suffering from the coronary artery disease to select program participants that are likely to benefit from physical activity;
analyzing data about the program participants and assigning a physical activity program to each program participant based on the data analyzed;
providing a computerized interface that permits each program participant to input information about their physical activity; and
periodically reassessing each program participant to determine if their physical activity program should be changed.

18. The method as claimed in claim 17 wherein screening the patients comprises determining a discharge category for each patient based on previous physical activity history, infraction recovery, and any co-morbidity.

19. The method as claimed in claim 17 further comprising requiring each program participant to select a program participation goal.

20. The method as claimed in claim 19 wherein analyzing the data comprises using the discharge category and the program participation goal of each program participant to select the physical activity program for the program participant.
